(19) United States
(12) Patent Application Publication
(10) Pub. No.: US 2012/0082092 A1
(43) Pub. Date: Apr. 5, 2012

(54) COMMUNICATION TERMINAL AND METHOD OF OPERATING THE SAME

(75) Inventor: Chi Jeong CHOI, Suwon-si (KR)

(73) Assignee: SAMSUNG ELECTRONICS CO. LTD., Suwon-si (KR)

(21) Appl. No.: 13/109,392

(22) Filed: May 17, 2011

(30) Foreign Application Priority Data
Sep. 30, 2010 (KR) 10-2010-0094878

(51) Int. Cl. H04W 88/02

(52) U.S. Cl. 370/328

(57) ABSTRACT

A communication terminal for wireless internet communication and a method of operating the same are disclosed. When entering a wireless internet communication mode, a switch unit is controlled to connect a communication pattern unit to a wireless internet communication unit. In the internet communication mode, the communication terminal accesses the wireless internet through the communication pattern unit and communicates with the wireless internet. When the wireless internet communication mode ends, the switch unit is controlled to ground the communication pattern unit. A supplementary device of the communication terminal is used as a part of the communication pattern unit for wireless communication so that installation space for an antenna may be secured in the communication terminal.

### PRIORITY

This application claims the benefit under 35 U.S.C. §119(a) of a Korean patent application filed on Sep. 30, 2010 in the Korean Intellectual Property Office and assigned Serial No. 10-2010-0094878, the entire disclosure of which is hereby incorporated by reference.

### BACKGROUND OF THE INVENTION

1. Field of the Invention:

The present invention relates to a communication terminal and a method of operating the same. More particularly, the present invention relates to a wireless communication terminal having an internal antenna and a method of operating the same.

2. Description of the Related Art:

In general, a wireless communication system provides a variety of multimedia services such as Global Positioning System (GPS), Bluetooth communication, Digital Multimedia Broadcasting (DMB), and wireless internet. In order to reliably provide the multimedia service through the wireless communication system, a high data transfer rate for large amounts of multimedia data should be guaranteed. To this end, research for improving performance of an antenna of a communication terminal is being carried out. This is because the antenna of the communication terminal is used during the data transmission and reception for the multimedia service.

Moreover, in order to improve portability of the communication terminal in the wireless communication system, the communication terminal becomes lighter, thinner, shorter, and smaller. When at least a part of an antenna such as a rod antenna and a helical antenna protrudes out of the communication terminal, it is not easy to carry the communication terminal and the antenna may be easily damaged. For these reasons, the antenna is implemented as an internal antenna in which an antenna is installed within the communication terminal, that is, an intenna.

However, as the communication terminal described above becomes smaller in size, there is a difficulty in securing a space necessary to install an antenna within the communication terminal This problem becomes more serious when the communication terminal provides multi-purpose functions. In other words, the more elements for achieving various functions that are installed in the communication terminal, the more difficult it is to secure the installation space for an antenna.

### SUMMARY OF THE INVENTION

An aspect of the present invention is to address at least the above-mentioned problems and/or disadvantages and to provide at least the advantages described below. Accordingly, an aspect of the present invention is to provide a small communication terminal

Another aspect of the present invention is to provide a communication terminal securing a space for installing an antenna.

In accordance an aspect of the present invention, a communication terminal is provided. The terminal includes a communication pattern unit for accessing a wireless communication network in a wireless communication mode, a wireless communication unit connected to the communication pattern unit for communicating through the communication pattern unit, and a switch unit for connecting the communication pattern unit to the wireless communication unit when entering the wireless communication mode and for grounding the communication pattern unit when the wireless communication mode ends.

The communication pattern unit may include a connector for providing an interface with an external device when the communication pattern unit is connected to the external device and for serving as a part of the communication pattern unit when the communication pattern unit is connected to the wireless communication unit. The communication pattern unit may collect audio signals in an audio processing mode.

In accordance with an aspect of the present invention, a method of operating a communication terminal is provided. The method includes connecting a communication pattern unit to a wireless communication unit by controlling a switch unit when entering a wireless communication mode, accessing a wireless communication network through the communication pattern unit in the wireless communication mode to communicate with the wireless communication network, and grounding the communication pattern unit by controlling the switch unit when the wireless communication mode ends.

The communication pattern unit may include a connector for providing an interface with an external device when the communication pattern unit is connected to the external device and for serving as a part of the communication pattern unit when the communication pattern unit is connected to a wireless communication unit. The method may further include, collecting audio signals through the communication pattern unit when the communication pattern unit is grounded, and processing the audio signals when being connected to the communication pattern unit.

According to the communication terminal and the method for operating the same, a supplementary device such as a microphone, a connector, and the like is used as a part of a communication pattern unit for the wireless communication. Thus, installation space for the communication pattern unit may be secured in a communication terminal By doing so, the installation space for the communication pattern unit in the communication terminal may be reduced and costs for securing the installation space may be also saved. In addition, a small communication terminal may be achieved.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating internal configuration of a communication terminal according to an exemplary embodiment of the present invention;

FIG. 2 is a flowchart illustrating operation of a communication terminal according to an exemplary embodiment of the present invention;

FIG. 3 is a block diagram illustrating internal configuration of a communication terminal according to another exemplary embodiment of the present invention; and

FIG. 4 is a flowchart illustrating operation of a communication terminal according to another exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

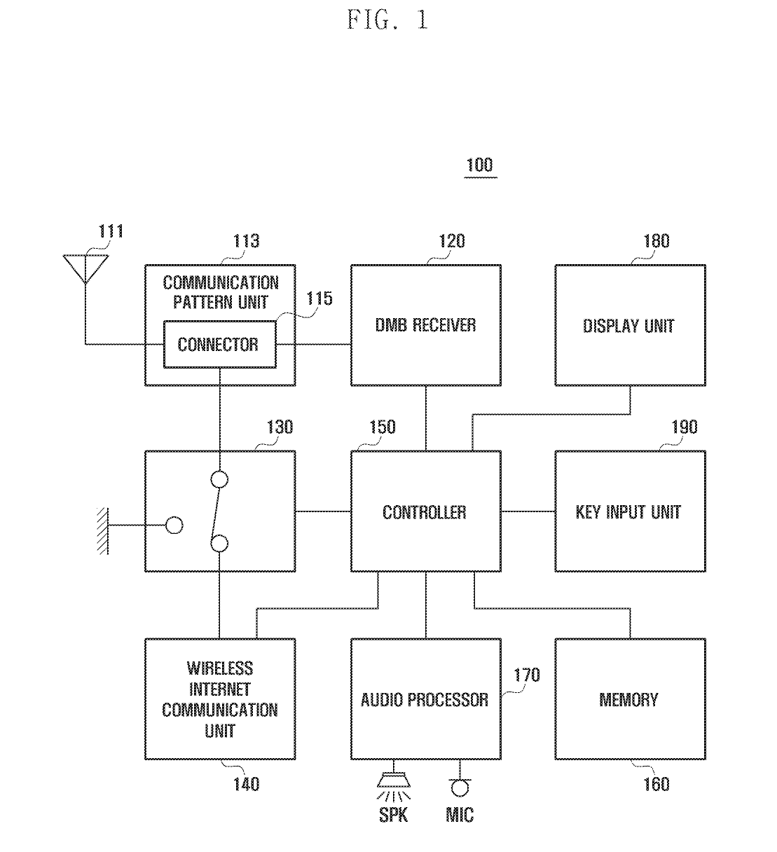

FIG. 1 is a block diagram illustrating internal configuration of a communication terminal according to an exemplary embodiment of the present invention. In this exemplary embodiment, it is assumed that the communication terminal is a mobile terminal However, the present invention is not limited thereto. Accordingly, the communication terminal may be any other type of terminal

Referring to FIG. 1, the communication terminal 100 according to the exemplary embodiment of the present invention includes a Digital Multimedia Broadcasting (DMB) antenna 111, a communication pattern unit 113, a DMB receiver 120, a switch unit 130, a wireless internet communication unit 140, a controller 150, a memory 160, an audio processor 170, a display unit 180, and a key input unit 190.

The DMB antenna 111 may be used to receive a DMB signal in a wireless environment. The DMB antenna 111 may be detachably attached to the communication terminal 100. That is, the DMB antenna 111 may be installed in the communication terminal 100 and may receive the DMB signal. The DMB antenna 111 may be an active component that is used to receive the DMB signal when electric power is supplied thereto and may discontinue receiving the DMB signal when the electric power is interrupted.

The communication pattern unit 113 may be used to access wireless internet. The communication pattern unit 113 is installed in the communication terminal 100. That is, the communication pattern unit 113 may be patterned on a main board (not shown) or a carrier (not shown) of the communication terminal 100 for installation in the communication terminal 100. The communication pattern unit 113 may be an active component that is used to access wireless internet when electric power is supplied thereto and may release the access to wireless internet when the electric power is interrupted. That is, the communication pattern unit 113 may serve as an antenna for wireless internet communication. The communication pattern unit 113 may include a connector 115.

The connector 115 is provided to interface with the DMB antenna 111 in the communication terminal 100. That is, when the DMB antenna 111 is installed in the communication terminal 100, the connector 115 is physically and electrically connected to the DMB antenna 111. When the DMB antenna 111 is operated, the connector 115 receives a DMB signal through the DMB antenna 111. Moreover, when the communication pattern unit 113 is operated, the connector 115 may serve as a part of the communication pattern unit 115. In this case, the connector 115 may serve to control gain of the communication pattern unit 113.

The DMB receiver 120 processes a DMB signal. The DMB receiver 120 is connected to the DMB antenna 111 through the connector 115. That is, when the DMB antenna 111 is operated, the DMB receiver 120 processes a DMB signal received through the connector 115. In this case, the DMB receiver 120 amplifies and corrects the DMB signal.

The switch unit 130 drives the communication pattern unit 113. In other words, the switch unit 130 may ground the communication pattern unit 113 to discontinue the operation of communication pattern unit 113. The switch unit 130 may release ground from the communication pattern unit 113 to operate the communication pattern unit 113.

The wireless internet communication unit 140 communicates with wireless internet. That is, the wireless internet communication unit 140 communicates with wireless internet through the communication pattern unit 113. In this case, when the communication pattern unit 113 is operated, the wireless internet communication unit 140 is connected to the communication pattern unit 113 through the switch unit 130. The wireless internet communication unit 140 includes a Radio Frequency (RF) transmitter performing up-conversion and amplification of transmitted frequencies and an RF receiver performing low-noise amplification and down-conversion of the received frequencies.

The controller 150 controls overall operations of the communication terminal 100. The controller 150 may include a data processor having a transmitter encoding and modulating a transmitting signal and a receiver decoding and demodulating a received signal. In this case, the data processor may be a MODEM or a CODEC. The CODEC includes a data CODEC processing packet data and an audio CODEC processing an audio signal such as sound. The controller 150 controls the switch unit 115. In other words, when entering the wireless internet communication mode, the controller 150 connects the communication pattern unit 113 to the wireless internet communication unit 140 using the switch unit 115 and supplies power to the communication pattern unit 113. When the wireless internet communication mode is finished, the controller 150 grounds the communication pattern unit 113 using the switch unit 115 and interrupts the power to the communication pattern unit 113. In other words, in the DMB receiving mode, the controller 150 may ground the communication pattern unit 113 using the switch unit 113.

The memory 160 may include a program memory and a data memory. The program memory stores programs controlling general operations of the communication terminal 100. The program memory stores programs for controlling the switch unit 115 to drive the communication pattern unit 113. The data memory stores data generated during the execution of programs.

The audio processor 170 processes an audio signal output from or to be transmitted to the audio CODEC of the data processor. The audio processor 170 reproduces a received audio signal output from the audio CODEC through a speaker SPK and transmits an audio signal generated from a microphone MIC to the audio CODEC.

The display unit 180 displays user data output from the controller 150. The display unit 180 may be a Liquid Crystal Display (LCD) or an Organic Light Emitting Diode (OLED). In this case, the display unit 180 may include a display controller, a display memory storing image data, and a display device. When the display unit 180 is a touch screen panel, the display unit 180 may serve as key input unit 190 or as an additional input unit.

The key input unit 190 includes keys for inputting numbers and characters and function keys for setting various functions.

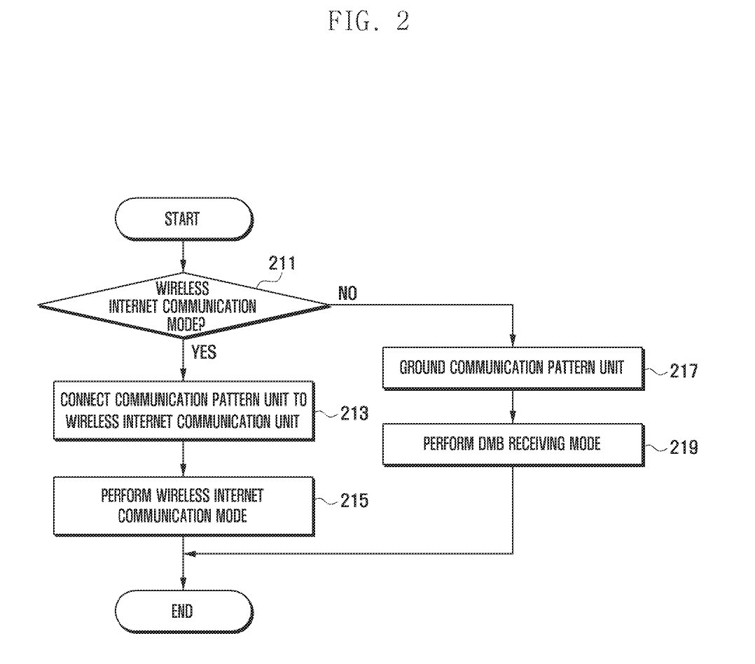

FIG. 2 is a flowchart illustrating operation of a communication terminal according to an exemplary embodiment of the present invention.

Referring to FIG. 2, the controller 150 of the communication terminal 100 determines whether the communication terminal 100 should operate in a wireless internet communication mode in step 211. If the controller 150 determines that the communication terminal 100 should operate in the wireless internet communication mode at step 211, the controller 150 connects the communication pattern unit 113 to the wireless internet communication unit 140 in step 213. That is, the controller 150 connects the communication pattern unit 113 to the wireless internet communication unit 140 using the switch unit 115 and supplies power to the communication unit 113. After that, the controller 150 performs the wireless internet communication mode in step 215. That is, the controller 150 accesses wireless internet through the communication pattern unit 113 and communicates via wireless internet through the wireless internet communication unit 140. The controller 150 may upload and download various types of information to and from wireless internet. The controller 150 may control the memory 160 to store various types of information and the audio processor 170 and the display unit 180 to reproduce the information.

In the wireless internet communication mode, the controller 150 may perform the DMB receiving mode. That is, the controller 150 may supply current to the communication pattern unit 113 and the DMB antenna 111. The controller 150 receives a DMB signal through the DMB antenna 111 and processes the DMB signal through the DMB receiver 120. The controller 150 may store the DMB signal in the memory 160 and reproduce the DMB signal using the audio processor 170 and the display unit 180.

If the controller determines that the communication terminal 100 should not operate in the wireless internet communication mode at step 211, the controller 150 grounds the communication pattern unit 113 in step 217. That is, the controller 150 grounds the communication pattern unit 113 using the switch unit 115 and interrupts the supply of power to the communication unit 113. However, the controller 150 supplies power to the DMB antenna 111. After that, the controller performs a DMB receiving mode in step 219. That is, the controller 150 receives a DMB signal through the DMB antenna 111 and processes the DMB signal using the DMB receiver 120. In this case, the connector 115 relays communication between the DMB antenna 111 and the DMB receiver 120. The controller 150 may store the DMB signal in the memory 160 or reproduce the DMB signal using the audio processor 170 and the display unit 180.

Although the communication pattern unit accesses wireless internet in this exemplary embodiment, the present invention is not limited thereto. The communication pattern unit may be a device for Bluetooth access or Global Positioning System (GPS) access. When the communication pattern unit is to perform the Bluetooth access, the wireless internet communication unit of the exemplary embodiment may be replaced by a Bluetooth receiver for Bluetooth communication. When the communication pattern unit is to perform GPS access, the wireless internet communication unit may be replaced by a GPS receiver to receive GPS information.

In this exemplary embodiment, the connector is for the connection with the DMB antenna, but the present invention is not limited thereto. The connector may be a Universal Serial Bus (USB) memory or a device for connecting the communication pattern unit to an external device, such as a USB cable. When the connector is implemented by the device for connecting the communication pattern unit to an external device, the DMB receiver may be replaced by a data communication unit processing data exchanged with the external device.

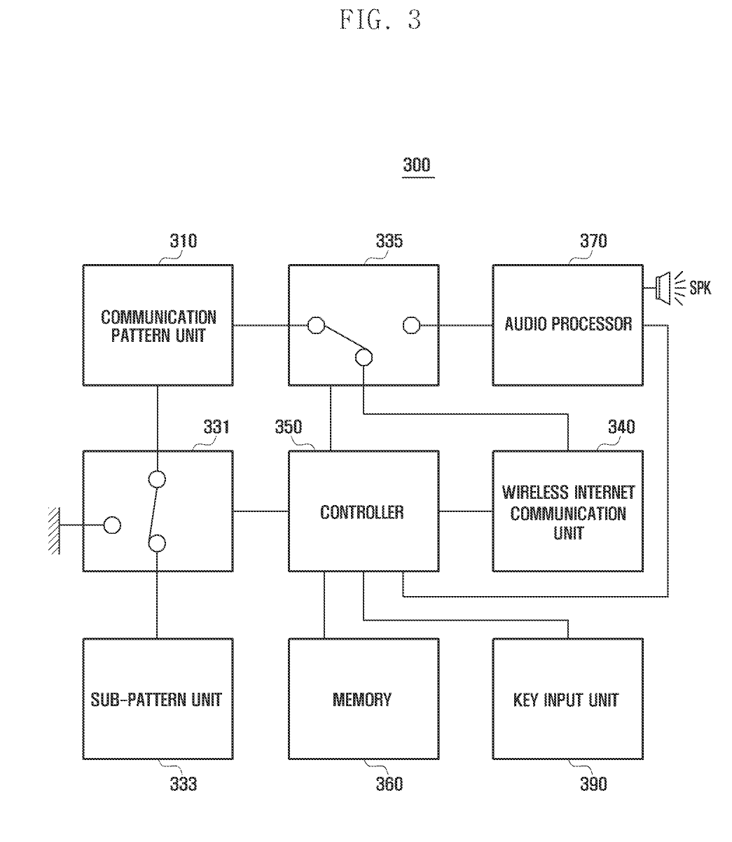

FIG. 3 is a block diagram illustrating internal configuration of a communication terminal according to another exemplary embodiment of the present invention. In this exemplary embodiment, it is assumed that the communication terminal is a telephone. However, the present invention is not limited thereto. Accordingly, the communication terminal may be any other type of terminal

Referring to FIG. 3, a communication terminal 300 according to this exemplary embodiment of the present invention includes a communication pattern unit 310, a supporting switch unit 331, a sub-pattern unit 333, a path switching unit 335, a wireless internet communication unit 340, a controller 350, a memory 360, an audio processor 370, and a key input unit 390.

The communication pattern unit 310 may be used to access wireless internet. That is, the communication pattern unit 310 may serve as an antenna. The communication pattern unit 310 collects audio signals. That is, the communication pattern unit 310 may serve as a microphone MIC. In this case, the communication pattern unit 310 is installed in the communication terminal 300. In other words, the communication pattern unit 310 may be patterned on a main board (not shown) or a carrier (not shown) of the communication terminal 300 for the installation in the communication terminal 310. The communication pattern unit 310 may be an active component that is used to access wireless internet when electric power is supplied thereto and may discontinue accessing wireless internet when the electric power is interrupted.

The supporting switch unit 331 supports electrical connection of the communication pattern unit 310. That is, the supporting switch unit 331 connects the communication pattern unit 310 to the sub-pattern unit 333 such that the communication pattern unit 310 serves as an antenna. The supporting switch unit 331 may ground the communication pattern unit 310 such that the communication pattern unit 310 serves as a microphone.

The sub-pattern unit 333 is provided to elongate the electrical length of the communication pattern unit 310. That is, the sub-pattern unit 333 may be coupled with the communication pattern unit 310 through the supporting switch unit 331. When the sub-pattern unit 333 is connected to the communication pattern unit 310 through the supporting switch unit 331, the sub-pattern unit 333 supports operation of the communication pattern unit 310. The sub-pattern unit 333 may be patterned on a main board or a carrier of the communication terminal 300 to be installed in the communication terminal 300.

The path switch unit 335 switches a signal transmitting path of the communication pattern unit 310. That is, the path switch unit 335 connects the communication pattern unit 310 to the wireless internet communication unit 340 or to the audio processor 370. When the communication pattern unit 310 serves as an antenna, the path switch unit 335 connects the communication pattern unit 310 to the wireless internet communication unit 340. When the communication pattern unit 310 serves as a microphone, the path switch unit 335 connects the communication pattern unit 310 to the audio processor 370.

The wireless internet communication unit 340 communicates with wireless internet. That is, wireless internet communication unit 340 communicates with wireless internet through the communication pattern unit 310. When the communication pattern unit 310 is operated, the wireless internet communication unit 340 is connected to the communication pattern unit 310 through the path switch unit 335. The wireless internet communication unit 340 includes an RF transmitter performing up-conversion and amplification of transmitted frequencies and an RF receiver performing low-noise amplification and down-conversion of the received frequencies.

The controller 350 controls overall operations of the communication terminal 300. The controller 350 may include a data processor having a transmitter encoding and modulating a transmitting signal and a receiver decoding and demodulating a received signal. In this case, the data processor may be a MODEM or a CODEC. The CODEC includes a data CODEC processing packet data and an audio CODEC processing an audio signal such as sound. The controller 350 controls the supporting switch unit 331 and the path switch unit 335. In other words, when entering the wireless internet communication mode, the controller 350 connects the communication pattern unit 310 to the sub-pattern unit 333 using the supporting switch unit 331 and the communication pattern unit 310 to the wireless internet communication unit 340 using the path switch unit 335. When the wireless internet communication mode is finished, the controller 350 grounds the communication pattern unit 310 using the supporting switch unit 331 and connects the communication pattern unit to the audio processor 370 using the path switch unit 333. In other words, in the audio processing mode, the controller 350 connects the communication pattern unit 310 to the audio processor 370.

The memory 360 may include a program memory and a data memory. The program memory stores programs controlling general operations of the communication terminal 300. The program memory stores programs for controlling the communication pattern unit 310. The data memory stores data generated during the execution of programs.

The audio processor 370 processes an audio signal output from or to be transmitted to the audio CODEC of the data processor. When the communication pattern unit 310 is operated, the audio processor 370 is connected to the communication pattern unit 310 through the path switch unit 335. The audio processor 370 reproduces an audio signal output from the audio CODEC through a speaker SPK and transmits an audio signal generated from a microphone MIC to the audio CODEC.

The key input unit 380 includes keys inputting numbers and characters and function keys setting various functions.

Although not shown, the communication terminal 300 may include a display unit that displays user data output from the controller 350. The display unit may be a Liquid Crystal Display (LCD) or an Organic Light Emitting Diode (OLED). In this case, the display unit may include a display controller, a display memory storing image data, and a display device. When the display unit is a touch screen panel, the display unit may serve as key input unit 390 or as an additional input unit.

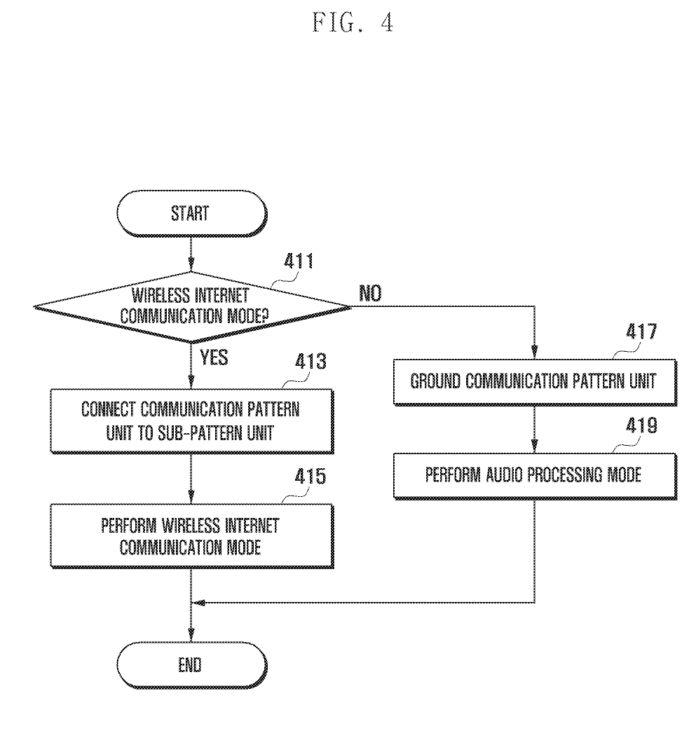

FIG. 4 is a flowchart illustrating operation of a communication terminal according to another exemplary embodiment of the present invention.

Referring to FIG. 4, the controller 350 of the communication terminal 300 determines whether the communication terminal 300 should operate in the wireless internet communication mode in step 411. If the controller 350 determines that the communication terminal 300 should operate in the wireless internet communication mode at step 411, the controller 350 connects the communication pattern unit 310 to the sub-pattern unit 333 in step 413. That is, the controller 350 connects the communication pattern unit 310 to the sub-pattern unit 333 using the supporting switch unit 331 and the communication pattern unit 310 to the wireless internet communication unit 340 using the path switch unit 335. The controller 350 supplies power to the communication pattern unit 310 to drive the communication pattern unit 310 to serve as an antenna. After that, the controller 350 performs the wireless internet communication mode in step 415. That is, the controller 350 accesses wireless internet through the communication pattern unit 310 and communicates via wireless internet through the wireless internet communication unit 340. The controller 350 may upload and download various types of information to and from wireless internet. The controller 350 may control the memory 360 to store various types of information and the audio processor 370 to reproduce the information.

If the controller 350 determines that the communication terminal 300 should not operate in the wireless internet communication mode at step 411, the controller 350 grounds the communication pattern unit 310 in step 417. That is, the controller 350 grounds the communication pattern unit 310 using the supporting switch unit 331 and connects the communication unit 310 to the audio processor 370 using the path switch unit 335. The controller 350 supplies power to the communication pattern unit 310 to drive the communication pattern unit 310 to serve as a microphone. After that, the controller 350 performs the audio processing mode in step 419. That is, the controller 350 collects audio signals through the communication pattern unit 310 and processes the audio signals through the audio processor 370. The controller 350 may store the audio signal in the memory 360 or reproduce the audio signal using the audio processor 370.

Although the communication pattern unit accesses wireless internet in this exemplary embodiment, the present invention is not limited thereto. The communication pattern unit may be a device for Bluetooth access or GPS access. When the communication pattern unit is to perform the Bluetooth access, the wireless internet communication unit of the exemplary embodiment may be replaced by a Bluetooth receiver for Bluetooth communication. When the communication pattern unit is to perform GPS access, the wireless internet communication unit may be replaced by a GPS receiver to receive GPS information.

According to exemplary embodiments of the present invention, when a supplementary device such as a microphone, a connector, and the like is used as a part of a communication pattern unit for the wireless communication, installation space of the communication pattern unit may be secured in a communication terminal By doing so, the installation space for the communication pattern unit in the communication terminal may be reduced and costs for securing the installation space may be also saved. In addition, a small communication terminal may be achieved.

While the invention has been shown and described with reference to certain exemplary embodiments thereof, it will be understood by those skilled in the art that various changes in form and details may be made therein without departing from the spirit of the invention as defined by the appended claims and their equivalents.

What is claimed is:

1. A communication terminal comprising:
a communication pattern unit for accessing a wireless communication network in a wireless communication mode;
a wireless communication unit connected to the communication pattern unit for communicating through the communication pattern unit; and
a switch unit for connecting the communication pattern unit to the wireless communication unit when entering the wireless communication mode and for grounding the communication pattern unit when the wireless communication mode ends.

2. The communication terminal of claim 1, wherein the communication pattern unit comprises a connector for providing an interface with an external device when the communication pattern unit is connected to the external device and for serving as a part of the communication pattern unit when the communication pattern unit is connected to the wireless communication unit.

3. The communication terminal of claim 2, further comprising:
an antenna for receiving a digital multimedia broadcasting in a digital multimedia broadcasting receiving mode; and
a digital multimedia broadcasting receiver for processing the digital multimedia broadcasting when the digital multimedia broadcasting is received,
wherein the connector relays communication between the antenna and the digital multimedia broadcasting receiver when the connector is connected to the antenna.

4. The communication terminal of claim 3, wherein the communication pattern unit relays communication between the antenna and the digital multimedia broadcasting receiver through the connector when the communication pattern unit is grounded, and relays communication between the antenna and the digital multimedia broadcasting receiver through the connector when the communication pattern unit is connected to the wireless communication unit by the switch unit.

5. The communication terminal of claim 1, wherein the communication pattern unit collects audio signals in an audio processing mode.

6. The communication terminal of claim 5, further comprising:
an audio processor for processing the audio signals when being connected to the communication pattern unit,
wherein the switch unit comprises a path switch unit for connecting the communication pattern unit to the wireless communication unit in the wireless communication mode and for connecting the communication pattern unit to the audio processor in the audio processing mode to switch a signal path.

7. The communication terminal of claim 6, further comprising:
a sub-pattern unit coupled with the communication pattern unit for supporting operation of the communication pattern unit,
wherein the switch unit further comprises a supporting switch unit for connecting the communication pattern unit to the sub-pattern unit in the wireless communication mode and for grounding the communication pattern unit in the audio processing mode.

8. A method of operating a communication terminal, the method comprising:
connecting a communication pattern unit to a wireless communication unit by controlling a switch unit when entering a wireless communication mode;
accessing a wireless communication network through the communication pattern unit in the wireless communication mode to communicate with the wireless communication network; and
grounding the communication pattern unit by controlling the switch unit when the wireless communication mode ends.

9. The method of claim 8, wherein the communication pattern unit comprises a connector providing an interface with an external device when the communication pattern unit is connected to the external device and serving as a part of the communication pattern unit when the communication pattern unit is connected to a wireless communication unit.

10. The method of claim 9, further comprising:
connecting an antenna to a digital multimedia broadcasting receiver through the connector in a digital multimedia broadcasting receiving mode when the communication pattern unit is grounded; and
receiving the digital multimedia broadcasting through the antenna and processing the received digital multimedia broadcasting.

11. The method of claim 10, further comprising:
connecting the antenna to the digital multimedia broadcasting receiver using the connector in the wireless communication mode; and
receiving the digital multimedia broadcasting through the antenna and processing the received digital multimedia broadcasting.

12. The method of claim 8, further comprising:
collecting audio signals through the communication pattern unit when the communication pattern unit is grounded; and
processing the audio signals when being connected to the communication pattern unit.

13. The method of claim 12, wherein the switch unit comprises a path switch unit connecting the communication pattern unit to the wireless communication unit in the wireless communication mode and connecting the communication pattern unit to an audio processor in an audio processing mode to switch a signal path.

14. The method of claim 13, wherein the switch unit further comprises a supporting switch unit connecting the communication pattern unit to a sub-pattern unit coupled with the communication pattern unit to support operation of the communication pattern unit in the wireless communication mode, and grounding the communication pattern unit in the audio processing mode.
